(19) United States
(12) Patent Application Publication
(10) Pub. No.: US 2023/0257287 A1
(43) Pub. Date: Aug. 17, 2023

(54) COMBINED ELECTROCHEMICAL PRE-TREATMENT AND SORPTION OF POLLUTANTS

(71) Applicant: Claros Technologies Inc., Minneapolis, MN (US)

(72) Inventors: Abdennour Abbas, Falcon Heights, MN (US); John Wilfrid Brockgreitens, Minneapolis, MN (US); Evan Anthony Leslie, Minneapolis, MN (US); Conor Hogan Broderick, Minneapolis, MN (US)

(73) Assignee: Claros Technologies Inc., Minneapolis, MN (US)

(21) Appl. No.: 18/101,378

(22) Filed: Jan. 25, 2023

Related U.S. Application Data
(60) Provisional application No. 63/302,899, filed on Jan. 25, 2022.

(51) Int. Cl. C02F 1/469; C02F 1/28

(52) U.S. Cl. CPC C02F 1/469; C02F 1/288; C02F 2101/20; C02F 2305/08

(57) ABSTRACT

The present invention relates to systems and methods whereby contaminants or pollutants are removed from a fluid using a combination of electrochemical treatment and sorption. The systems and methods described herein may be used to remove pollutants from water or other fluids. The systems and methods described herein apply an electric current to a contaminated fluid such as water. The target contaminants are consequently ionized and are forced through a reactive sorbent media by use of an electrical gradient or polarization. The sorbent chemically binds the contaminants.

### CROSS REFERENCE TO RELATED APPLICATIONS

The present application claims priority to U.S. Provisional Application Serial No. 63/302,899 filed Jan. 25, 2023 and entitled COMBINED ELECTROCHEMICAL PRE-TREATMENT AND SORPTION OF POLLUTANTS, the content of which is hereby incorporated into the present application in its entirety.

### BACKGROUND

Environmental pollution may be caused by industrial processes, fossil fuels, waste disposal, plastics, and other processes and materials. Many pollutants have the potential to cause significant harm to people, but once they are free in the environment, they are extremely difficult to remove. Pollution of waterways is of particular concern since we rely on clean drinking water to survive, and even very low levels of contamination may be damaging. People are increasingly aware of the need to prevent the release of pollutants into the environment. However, the environment is already contaminated by pollutants released in the past, and harmful pollutants continue to be released or to escape into the environment.

Pollution, particularly heavy metal pollution and organic contaminant pollution, present significant challenges in water remediation. Inorganic heavy metal pollution from constituents like mercury (Hg), represents a major threat to aquatic life and human health by entering the food chain. Mercury contamination of surface waters results in mercury accumulation in fish, leading health agencies globally to establish fish consumption guidelines. (Lamborg et al., 2014) The removal of mercury and other toxic metals from water is a key challenge for many sites including mining operations, power plants, waste handling facilities, and dental offices. In dentistry, for example, mercury is used as an ingredient in amalgam fillings along with metals including silver, indium, and tin. (George et al., 2009) When amalgam fillings are put in place or excavated, mercury-containing particles are captured by dentists and sent down the drain. According to the US-EPA, there are over 100,000 dental clinics in the US that discharge approximately 5.1 metric tons of Hg each year into publicly owned water treatment works, with a cost of Hg removal of $82 million/year, despite the use of filter systems. (Goodis, 2017)

Organic pollution from constituents like perfluoroalkyl and polyfluoroalkyl substances (PFAS) and other persistent organic pollutants also present challenges to water quality. PFAS are a broad category of synthetic organofluorine compounds where all (per-) or some (poly-) of the hydrogen atoms in the alkyl chain are replaced by fluorine. PFAS have been widely used in waterproof coatings, firefighting foams and in chemical manufacturing. These compounds have been shown to be highly mobile and bio-accumulative in both animals and humans, leading to associated health impacts including cancer and kidney failure. (Grandjean & Clapp, 2015; Rahman et al., 2014)

A major obstacle to removing inorganic and organic contaminants from water is their ability to change solubility and surface charge as a function of water quality metrics including pH, ionic strength, and redox potential. For metals, the chemical form can vary in these systems ranging from dissolved, ionic forms to solid phase elemental (zero-charge) form or solid phase oxides/hydroxides. (Atwood & Zaman, 2006) Similarly, the overall charge and solubility of organic compounds can change dramatically with protonation and deprotonation of functional groups within the compounds. (Nguyen et al., 2020) The presence of these mixed phases complicates removal with conventional filter systems. One significant limitation for conventional filter systems, such as amalgam separators, is the removal of very fine solid-phase or uncharged particles from the air or water stream. These particles, ranging in size from 10 nanometers (nm) to 3 micrometers (µm), are able to pass through conventional size exclusion filter systems, which typically remove larger particles from 3 - 0.5 µm. (Stone et al., 2008) Furthermore, these small particles are uncharged and do not typically interact with adsorbent media like activated carbon.(Gai et al., 2019; Kah et al., 2021) Other selective adsorbent materials like ion exchange resins are highly dependent on the overall charge of the constituent to be removed. (Kah et al., 2021; Kucharzyk et al., 2017)

Current approaches for treating mixed phase contamination streams include the addition of coagulants to precipitate ionic constituents, addition of acids and bases to stabilize pH, and the addition of oxidizers or reducing chemicals to yield the desired chemical form. These methods require constant, controlled inputs of chemicals, incurring higher, repeated costs for treatment systems.

Electrochemistry, the use of electricity to facilitate chemical reactions, has been utilized in environmental remediation. In a typical set up for water, the anode and cathode are added to a water sample and a current is applied. The target constituent is ionized and removal is achieved through two mechanisms 1) precipitation in solution and settling or 2) collection on the surface of the electrode. (Drogui et al., 2008; Pulkka et al., 2014) These methods have drawbacks in that they require frequent removal and disposal of the precipitate, which itself can be a hazardous material. Furthermore, precipitation of materials on the surface of the electrode causes fouling and loss of performance.

Improved methods are needed for capturing pollutants and for managing the end product of pollutant capture.

### SUMMARY OF THE INVENTION

The present invention relates to systems and methods whereby contaminants or pollutants are removed from a fluid using a combination of electrochemical treatment and sorption. The systems and methods described herein may be used to remove pollutants from water or other fluids. The systems and methods described herein apply an electric current to a contaminated fluid such as water. The target contaminants are consequently ionized and are forced through a reactive sorbent media by use of an electrical gradient or polarization. To achieve polarization, power is supplied to both electrodes: an anode located in one side of the vessel and a cathode located in the opposite vessel linked by a sorbent containing bridge. The sorbent acts to chemically bind the dissolved, ionized constituents to the sorbent media.

In one embodiment, a system for removal of a targeted pollutant comprises an electrochemical cell. The electrochemical cell comprises a first fluid chamber including a cathode and a second fluid chamber including an anode. A sorbent is located in a fluid bridge between the first and second chamber. The sorbent allows the passage of electrical current between the first and second fluid chambers. The targeted pollutants are forced through the sorbent and chemically bound to the sorbent.

### BRIEF DESCRIPTION OF THE DRAWINGS

While the specification concludes with claims particularly pointing out and distinctly claiming the subject matter that is regarded as forming the various embodiments of the present disclosure, it is believed that the disclosure will be better understood from the following description taken in conjunction with the accompanying Figures, in which:

FIG. 1 is a schematic representation of an electrochemical treatment system according to various embodiments;

FIG. 2 is a schematic representation of an alternative embodiment of an electrochemical treatment system;

FIG. 3 is a schematic representation of another alternative embodiment of an electrochemical treatment system; and

FIG. 4 is a photograph of an electrochemical system including wastewater a. before treatment and b. after treatment.

### DETAILED DESCRIPTION

The present invention relate to a process whereby contaminants or pollutants are removed from a fluid using a combination of electrochemical treatment and sorption. The systems and methods described herein may be used to remove pollutants from water or other fluids. The systems and methods described herein apply an electric current to a contaminated fluid such as water. The target contaminants are consequently ionized and are forced through a reactive sorbent media by use of an electrical gradient.

The pollutants which may be removed include but are not limited to inorganic pollutants metals such as cadmium, lead, mercury, gold and silver, as well as organic contaminants like PFAS, polycyclic aromatic hydrocarbons, dioxanes, hormones, antibiotic compounds, and volatile organic compounds (VOCs). Some embodiments may be capable of absorbing more than one pollutant simultaneously. Examples of PFAS which may be removed include synthetic organofluorine compounds such as perfluorooctanoic acid (PFOA) and perfluorooctanesulfonic acid (PFOS). Various embodiments are particularly useful for pollutants having mixed phases, such as combinations of dissolved ionic forms, solid phase elemental forms (zero charge) and/or solid phase oxides and hydroxides, and pollutants having more than one charge or solubility depending upon conditions. In some cases, the constituent to be removed from water is a valuable material that may be captured and recovered. Example include inorganic materials like lithium, cobalt, cadmium, nickel, silver, gold, and platinum and organic materials like pharmaceutical compounds and amino acid molecules.

The electrochemical process utilized in various embodiments may include one or more of two primary mechanisms for electrochemical treatment of the pollutant, electrochemical oxidation and reduction as shown in the representative example below:

Electrochemical Oxidation: Hg⁰ (s) ↔ Hg²⁺(aq) + 2e⁻ (aq)

Electrochemical Reduction: Ag²⁺ (aq) + 2e⁻ (aq) ↔ Ag⁰ (s)

While the examples above show a process of oxidation of mercury and reduction of silver respectively, these are merely examples and other oxidation or reduction processes may be employed with any of the other contaminants which may be removed using the systems and methods described herein.

The methods and systems include two chambers in fluid communication with each other through a sorbent medium, with the location of the sorbent medium acting as a bridge between the two chambers and thus may be considered a third chamber. Alternatively, rather than including separate chambers, the system may be formed of a single large chamber having first and second portions which are separated by the sorbent medium between them. As such, while this application generally discusses the first, second, third, and fourth chambers, it should be understood that such chambers could each be separate vessels of alternatively one or more chambers could be chamber portions rather than distinct chambers. The first and second chambers each include an electrode, either a cathode or an anode with the cathode and an anode each located in one or the other chamber. The third chamber or bridge chamber includes the sorbent which occupies the full cross section of the fluid connection in the bridge chamber. As such, the only fluid connection between the first and second chambers is through the bridge chamber, through the sorbent within the bridge chamber. The cathode and anode are connected to a power source so that current can be applied to the system. Upon the application of an electric current, the target pollutant(s) are converted to a chemical form that can be captured by the sorbent as discussed later in this disclosure.

The first and/or second chambers may optionally include additives, such as those to facilitate electrolysis. For example, the first chamber and/or second chamber may include one or more additives such as electrolyte salts such as magnesium chloride, sodium chloride, or zinc chloride, as well as other additives such as hydrochloric acid, sulfuric acid, or acetic acid, among others. One of the first or second chambers may include an unpolluted fluid such as water, while the other of the first or second chambers may include a polluted fluid such as a wastewater with pollutants which are targeted for removal using the system.

The sorbent contained in the bridge chamber may be a targeted sorbent selected for removal of one or more target pollutants from the contaminated fluid. Examples of sorbents which may be used include ion resins, activated carbon, and nanocomposite sorbents such as Clarosafe Hg (Clarosafe Hg is a trademark of Claros Technologies Inc and subject of U.S. Pat. Publication 2021/0331137, the relevant portions of which are incorporated herein by reference), such as in cases wherein wastewater treatment of mercury or other appropriate target pollutants is desired. Sorbents which may be used include materials with high surface area that allow for binding or sorption of target pollutants from water. These binding interactions include but are not limited to electrostatic interactions, hydrogen bonding, covalent bonding, and ion exchange. For the application in an electrochemical device as described here, these sorbents may preferably be porous in nature and not hinder the flow of electricity between the chambers of the system.

A nanocomposite sorbent such as Clarosafe Hg may be used in various embodiments to absorb one or more pollutants from the fluid such that the pollutant is bound to the sorbent. Later, in some embodiments, the pollutant may then be released from the sorbent, the sorbent may be recycled, and the pollutant may be detoxified. Various types of sorbent systems may be used. In some embodiments, the sorbent comprises a foam such as a polyurethane. In some embodiments, the sorbent system includes nanoparticles. In some such embodiments, the sorbent system includes a support matrix such as a foam with nanoparticles on and within the foam matrix as a nanocomposite. In some embodiments, the nanocomposite is a two phase material including a metal or non-metal nanoparticle on the surface of and within a support matrix. The nanoparticle may have a size in the nanoscale range such as approximately 1 nm and 1000 nm, or between approximately 100 nm and 700 nm. The matrix may be porous, having a sponge-like structure, with the nanoparticles bound to the porous interior and exterior surfaces of the matrix throughout the pores. The matrix may function as a support structure for the metal or non-metal nanoparticles bound to its surface. In some embodiments, the particles may be one or more metals or metal oxides such as copper, iodine, silver, tin, zinc, titanium, selenium, nickel, iron, cerium, zirconium, magnesium, manganese, copper oxide, titanium dioxide, iron oxide and zinc oxide, non-metals such as selenium and carbon, including graphene, graphite and their oxides, or combinations of more than one of these or other nanoparticles or alloys thereof. Sorbent systems including nanoparticles useful in various embodiments may be created using a thermal reduction process to create nanocomposites of metallic or non-metallic nanoparticles bound within a matrix. The particular nanoparticles and matrix used may be selectively tailored to improve adsorption of one or more specific target pollutants. The sorbents including nanocomposites used in various embodiments may be produced using a thermal synthesis method such as that disclosed in U.S. Pat. Publication 2021/0331137 the relevant portions of which are hereby incorporated by reference.

The first chamber may include a counter electrode (cathode) including but not limited to rhodium, platinum, or graphite. The second chamber may contain a working electrode (anode) including but not limited to gold, glassy carbon, zinc, stainless steel, or nickel alloy, as well as a reference electrode, including but not limited to silver / silver chloride, mercury / mercury oxide, or saturated calomel. The only fluid connection between the first and second chambers is through the bridge chamber which contains the sorbent for the one or more target pollutants.

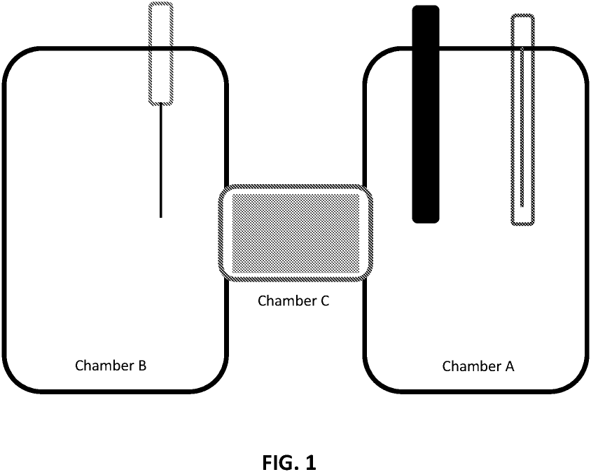

Examples of treatments systems which may be used in various embodiments are shown in FIGS. 1 through 3. The treatment system shown in FIG. 1 includes a first chamber labeled as Chamber A which may be used for receiving wastewater. The first chamber includes a cathode, a wastewater inlet and a wastewater outlet. The treatment system further includes a second chamber labeled as Chamber B which includes an anode. The first and second chambers are connected through a third chamber which is a bridge chamber labeled as chamber C including sorbent.

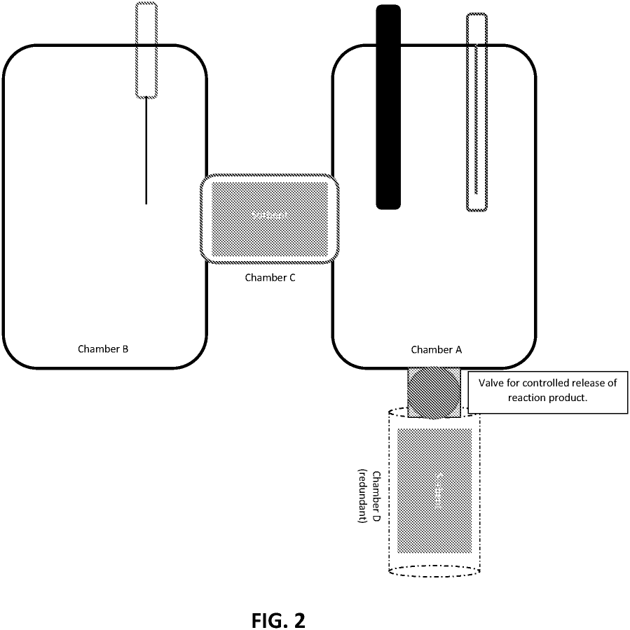

An alternative embodiment of a treatment system is shown in FIG. 2. Like the system shown in FIG. 1, the system in FIG. 2 includes first and second chambers labeled as Chambers A and B, with electrodes for the application of current and a bridge chamber, labeled as Chamber C which includes sorbent. At the bottom of the first chamber, the system also includes a valve for the controlled release of reaction product. Downstream of the release valve there is an optional fourth chamber, labeled as Chamber D, which may include sorbent and/or one or more selective membranes for redundant capture or additional capture of contaminants remaining in the purified wastewater stream after electrochemical treatment and release from the first chamber.

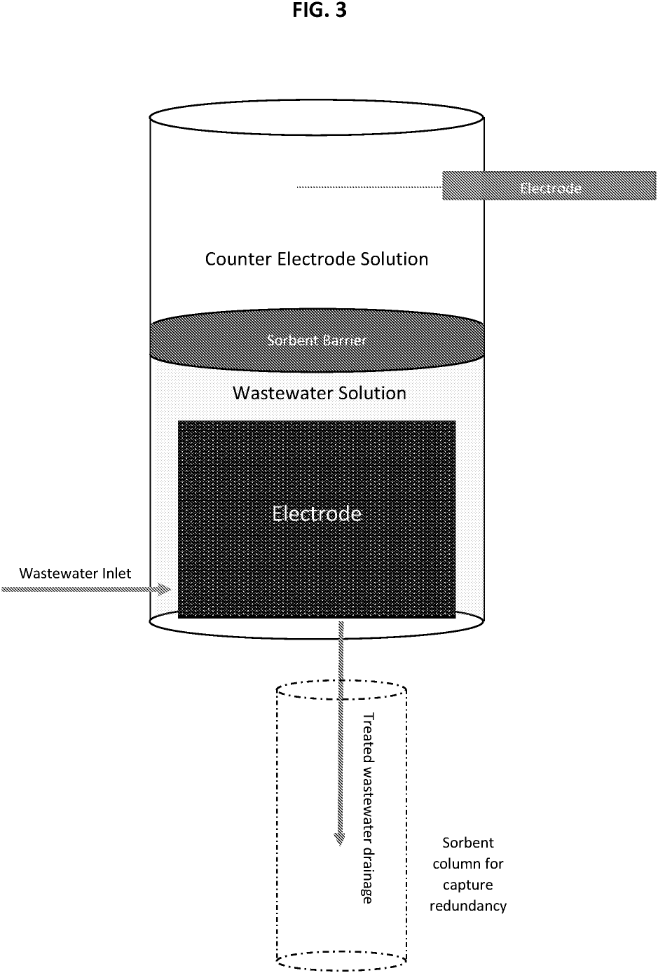

Another alternative embodiment in shown in FIG. 3, in which the first and second chambers are first and second portions of a single large container and are separated from each other by a sorbent barrier rather than a bridge. In the example shown, the first and second chambers are in a vertical orientation with the wastewater solution in the lower chamber and with a wastewater treatment release at the bottom, optionally passing through an additional sorbent column for redundant capture, like Chamber D in FIG. 2. The system may further include an optional release valve, not shown, between the wastewater portion and the outflow, like the embodiment shown in FIG. 2. In alternative embodiments, the wastewater solution could alternatively be oriented toward the top, with relocation of the wastewater inlet and release as needed, or the system could be vertically oriented with the first and second chambers side by side. In some embodiments, the system may use one or more membranes as a barrier instead of a sorbent barrier. Alternatively, the system may include one or more membranes and a sorbent barrier.

Although not shown, the system may include additional inlets or outlets which may be regulated by valves at various locations, such as in the first, second, third or fourth chambers. Furthermore, the locations of the cathode and anode may be as shown or may be reversed in any embodiment.

The systems described herein may be used to remove pollutants from a contaminated fluid using a process that includes applying a voltage within the first and second chamber by an external power source, such as an electrochemical workstation. This voltage may range from 1 mV - 50 V (with 1-10 V being ideal) and may be applied for periods of time ranging from 10 minutes to 100 hours, with 4 to 48 hours being ideal in some embodiments. Application of voltage induces a change of chemical state for organic and inorganic pollutants - either via oxidation or reduction. These chemical constituents, referred to here as “ionizable pollutants,” can be understood as chemicals that experience changes such as a change in charge (ionization) or a change in physical state (such as a solid to liquid conversion). Ionizable inorganic pollutants which may be removed using these processes include but are not limited to mercury, lead, cadmium, arsenic, or manganese or iron including relevant oxide or hydroxide species. Ionizable organic pollutants which may be removed using these processes include but are not limited to PFAS, polycyclic aromatic hydrocarbons, organophosphorus pesticides, neonicotinoid insecticides, and dioxanes. Ionizable high value constituents that may be removed and recovered from water include but are not limited inorganic materials like lithium, cobalt, cadmium, nickel, silver, gold, and platinum and organic materials like pharmaceutical compounds and amino acid molecules. In some embodiments, the pollutants which may be removed includes solids of nanometer size, such as solids between about 10 nm and about 1000 nm. In other embodiments, the pollutants may be in the micrometer size, such as solids between 0.5 and 1000 µm. These pollutants may be solid particles or amalgams or alloys of solid particles. Examples include dental amalgam and electronic components containing macro scale-solid mercury (> 1 mm).

In some embodiments, the systems and methods may be used for the removal of metal solids including but not limited to mercury, silver, lead and their respective oxides, reduced and organic bound forms. In such embodiments, the method of ionization is oxidation, and therefore takes place in the second chamber, containing the anode. Upon ionization and subsequent dissolution of metal solids, the applied voltage will induce travel of positive-charge metal ions towards the first chamber, containing the cathode. By necessity, these metal ions must travel through the bridge chamber, thereby resulting in capture by the sorbent therein. In other embodiments, reduction may be the method of electrochemistry upon target pollutant, occurring in the first chamber containing the cathode. After reduction of the pollutant, the applied voltage induces travel towards the first chamber, again through the bridge chamber. In brief, the systems and methods described herein allows for the transformation of a pollutants and high value recoverable materials such as solid metals including but not limited to mercury, lead, cadmium, arsenic, manganese, iron, or gold or platinum including relevant oxide or hydroxide species as well as metal containing mineral particles including but not limited to lithium containing titanium, aluminum, or manganese particles and their relevant oxides and hydroxides, of these such that they are ionized and subsequently dissolved into solution, followed by the electrically-induced travel of said dissolved constituents into a sorbent. In this way, the systems and methods provide an integrated procedure for targeted pollutant capture, without need of pre-treatments such as filtration or chemical oxidation or reduction. Further, the systems and methods present a more complete means of treatment for contaminants including solid contaminants, in contrast to other methods of filtration or chemical absorption which are unable to reliably treat nanometer-scale solids.

The systems and methods described herein may produce a lower or higher redox potential in the reaction chamber (first or second chamber, respectively), through the respective electrochemical reduction and oxidation inherent in the application of voltage / current.

After completion of the process, the solution in the chambers (either the chamber originally including the polluted fluid such as the second chamber, and/or the chamber toward which the ionized pollutant migrated) may be released into the environment or may be subject to further treatment. For example, one or both of the end solutions, such as the fluid in the second chamber, may be treated through use of reducing agents including but not limited to ascorbic acid or activated carbon before its disposal, in order to avoid issues of releasing legacy waste as effluent flows through plumbing.

The compounds captured by the systems and methods described herein may be present in water in the environment, for example. The sorbent system may be used to remove the compounds from water at a water treatment plant or within surface or underground bodies of water such as lakes, rivers, groundwater and wells, for example. However, in some embodiments, removal of these compounds may occur prior to expulsion into the environment, such as in an industrial setting like in wastewater prior to or during expulsion from an industrial plant, such that the pollutant is never released or the release is minimized, or during a manufacturing process such as a chemical manufacturing process. Thus, while this disclosure refers to the captured compounds as pollutants, it extends to other compounds which never become pollutants or are not typically pollutants but for which there is a need to capture and remove them from a liquid or gas in which they are present.

The system and methods described herein provide for the treatment of contaminated fluids such as water via electrochemical means to convert constituents into forms that can be captured via sorbents. This invention overcomes significant limitations of conventional filters regarding the removal of very fine solid-phase particles and uncharged organic contaminants from an air or water stream. The described process is undertaken in a system that contains three chambers that is comprised of an oxidation chamber, reduction chamber, and sorbent chamber such as a sorbent cartridge. This system overcomes limitations of current technologies, particularly the ability to treat multiphase, complex matrices with one sorbent technology, and the elimination of hazardous precipitates. This system is further capable of extending the usable life of the electrochemical system by reducing or preventing fouling of the cathode and/or anode as the ionized pollutants migrate away, into the sorbent, where they are captured. After completion of the process, the sorbent material that has been utilized for pollutant removal may be subjected to a extraction process whereby a valuable constituent is recovered from the sorbent. This may be accomplished by methods including but not limited to the addition of a solution to the chamber at a high or low pH and applying an electric current to displace the captured target with a proton or hydroxide. A competitive ion may also be utilized in this process. For example, a sorbent containing lithium may be subjected to a solution containing sodium. Upon the addition of an electric current, the sodium is driven into the sorbent through an electrochemical gradient and displace the lithium bound in the sorbent, releasing lithium ions into solution whereby these ions can be utilized for value added products.

### Experimental

### Example 1

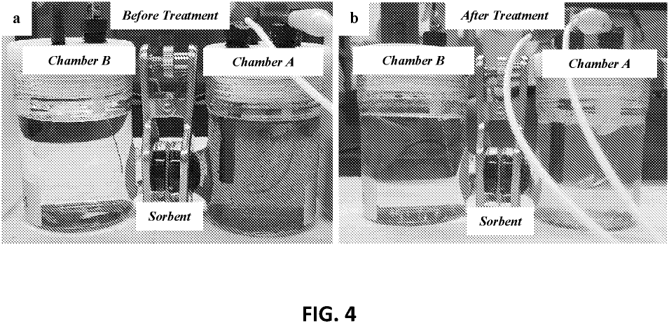

The systems and methods described herein were used successfully to treat a wastewater containing solid mercury. As described above, a current was applied to the waste stream to liberate and ionize mercury. These mercury ions then travelled through the sorbent, Clarosafe Hg, through an electrochemical gradient. Photos of the electrochemical treatment system are shown in FIG. 4. In image a, before treatment, Chamber A is filled with wastewater containing mercury while Chamber B is filled with clean water. Image b shows the system after treatment through the application of current across chambers A and B.

The results are shown in Table 1, below, indicating the mercury concentration (parts per billion, ppb, µg/L) in the reactor system before and after treatment reaction. As can be seen, with this system over 98% of the mercury was removed from the water through the dissolution/ionization of solids as subsequent sorption. Chamber C had a sorbent capture efficiency of greater than 98.9%.

TABLE 1

| Sample | [Hg] ppb |
|---|---|
| Chamber A, insoluble Mercury-containing waste | > 611 |
| Chamber A Post-Reaction | 0 |
| Chamber B Pre-Reaction solution | 0 |
| Chamber B Post-Reaction solution | 6.93 |

### Example 2

The systems and methods described herein were used successfully to dissolve solid mercury in dental wastewater. As described above, a current was applied to the waste stream contained in a 1-liter waste vessel to liberate and ionize mercury. After electrochemical treatment, the resulting dissolved mercury that remained after electrochemical treatment was then captured in a secondary vessel with Clarosafe Hg. The results are shown in Table 2, below, indicating the mercury concentration (parts per billion, ppb, µg/L) in the reactor system before and after treatment reaction. As can be seen, with this system, over 93% dissolution of the initial solid mercury was achieved. This dissolved mercury was then completely removed from the solution using Clarosafe Hg.

TABLE 2

| Sample | [Hg] ppb |
|---|---|
| Dental Amalgam Waste - Solid Mercury | 724 |
| Treated Dental Amalgam Waste - Solid Mercury | 53 |
| Percent Dissolution | 93% |

As used herein, the terms “substantially” or “generally” refer to the complete or near complete extent or degree of an action, characteristic, property, state, structure, item, or result. For example, an object that is “substantially” or “generally” enclosed would mean that the object is either completely enclosed or nearly completely enclosed. The exact allowable degree of deviation from absolute completeness may in some cases depend on the specific context. However, the nearness of completion will be so as to have generally the same overall result as if absolute and total completion were obtained. The use of “substantially” or “generally” is equally applicable when used in a negative connotation to refer to the complete or near complete lack of an action, characteristic, property, state, structure, item, or result. For example, an element, combination, embodiment, or composition that is “substantially free of” or “generally free of” an element may still actually contain such element as long as there is no significant effect thereof.

In the foregoing description various embodiments of the invention have been presented for the purpose of illustration and description. They are not intended to be exhaustive or to limit the invention to the precise form disclosed. Obvious modifications or variations are possible in light of the above teachings. The embodiments were chosen and described to provide illustrations of the principals of the invention and its practical application, and to enable one of ordinary skill in the art to utilize the invention in various embodiments and with various modifications as are suited to the particular use contemplated. All such modifications and variations are within the scope of the invention as determined by the appended claims when interpreted in accordance with the breadth they are fairly, legally, and equitably entitled.

What is claimed is:

1. A system for removal of a targeted pollutant comprising an electrochemical cell, the electrochemical cell comprising;
a. a first fluid chamber including a cathode;
b. a second fluid chamber including an anode
c. a sorbent located in a fluid bridge between the first and second chamber, wherein the sorbent allows for the passage of electrical current between the first and second fluid chambers.

2. The system of claim 1 wherein the electrochemical cell is configured to simultaneously produce dissolution, ionization and sorption of the target pollutant.

3. The system of claim 2 wherein the target pollutant is in water.

4. The system of claim 3 wherein the target pollutant comprises a nanometer-scale solid.

5. The system of claim 3 wherein the pollutant comprises a micrometer-scale solid.

6. The system of claim 3 wherein the target pollutant comprises solid mercury.

7. The system of claim 3 wherein the target pollutant comprises a mixture of nanometer or micrometer-scale solids.

8. A method of removing a targeted pollutant from a fluid using the system of claim 1, the method comprising:
a. adding the fluid containing the pollutant to either the first or second chamber;
b. adding a fluid to the other of the first or second chamber;
c. applying an externally applied voltage to the electrochemical cell.
